(19) United States
(12) Patent Application Publication
(10) Pub. No.: US 2026/0046189 A1
(43) Pub. Date: Feb. 12, 2026

(54) UNIFIED MULTIPLE ACCESS (MA) BASED SYSTEM FOR UPLINK TRANSMISSION OF DATA BY MULTIPLE USERS

(71) Applicant: INDIAN INSTITUTE OF TECHNOLOGY KHARAGPUR, KHARAGPUR (IN)

(72) Inventors: B. V. Sudhakar Reddy, Kharagpur (IN); Chaithanya Velampalli, Kharagpur (IN); Suvra Sekhar Das, Kharagpur (IN)

(21) Appl. No.: 18/966,032

(22) Filed: Dec. 2, 2024

(30) Foreign Application Priority Data
Aug. 6, 2024 (IN) 202431059503

(51) Int. Cl. H04L 27/36; H04L 5/00

(52) U.S. Cl. CPC H04L 27/362; H04L 5/0007

(57) ABSTRACT

The present invention discloses an unified multiple access (MA) based system for uplink transmission of data by multiple users. The system comprises an user interface integrated transmitter modules for transmitting the data from multiple user transmitters over waveforms through a cooperative unified data grid structure including grid points, said unified data grid structure including each user transmitter allocation of a few non-overlapping grid points for loading respective data bearing symbols, with zeros loaded onto unallocated grid points. The user transmitter is configured to transmit a sparsely loaded grid resembling to the unified two-dimensional data grid structure involving data-bearing Quadrature Amplitude Modulation (QAM), where a part of available grid points of the grid as allocated is loaded with QAM symbols and remaining grid points are loaded with zero symbols. A waveform modulator corresponding to user transmitter is also provided in the present system for waveform modulation of said sparsely loaded grid as per the waveforms enabling transmission for multi-antenna reception of the waveforms to a base station or an access point.

### FIELD OF THE INVENTION

The present invention relates to a multiple access (MA) mechanism based communication system. More specifically, the present invention is directed to provide uplink multiple access mechanism based multi-user communication system using multiple waveforms such as OTFS (orthogonal time frequency space), OFDM (orthogonal frequency-division multiplexing), OTSM (orthogonal time sequency multiplexing), and block single carrier (SC) for transmission of data by multiple users to a base station (BS). The present multiple access mechanism based system is resilient in high-speed scenarios, reduces high peak power requirements, and facilitating the development of multi-user receivers for practical pulse shapes, which were the problems in the art.

### BACKGROUND ART

Multiple access (MA), like multiplexing, involves sharing a communications resource between several users allowing all users to transmit data to a base station or access point within a given time frame. Recently, some multiple access-based communication systems have been reported, e.g.,

| No. | Reference name | Main feature |
|---|---|---|
| [1] | V. Khammammetti et al. “Otfs- | Interleaved delay-Doppler |
| | based multipleacccess in high | multiple access (IDDMA) |
| | doppler and delay spread | scheme for OTFS is proposed. |
| | wireless channels,” IEEE | Users are allocated interleaved |
| | Wireless Communications | delayDoppler resource blocks |
| | Letters, vol. 8, no. 2, | with no guard bins. However, |
| | pp. 528-531, 2019. | individual user transmission is |
| | | limited to a part of the total |
| | | time-frequency grid, resulting |
| | | in a loss of time frequency |
| | | diversity. |
| [2] | Rose Mary Augustine et | Interleaved Time frequency |
| | al. “InterleavedTimeFrequency | multiple access (ITFMA) scheme |
| | Multiple Access Using OTFS | proposed. Users are allocated |
| | Modulation,” IEEE VTC - 2019 | interleaved TF resource blocks. |
| | (VTC2019-Fall), pp. 1-5, 2019. | Requires high complexity of |
| | | signal generation as a two step |
| | | signal generation is used for |
| | | OTFS. |
| [3] | T. Thaj al. “Orthogonal Time | Orthogonal Time Sequency |
| | Sequency Multiplexing | Multiplexing (OTSM) is |
| | Modulation: Analysis and Low- | presented. Multiple access |
| | Complexity Receiver Design,” | mechanisms to support multi- |
| | IEEE WCNC-2021, pp. 1-7, 2021 | user in uplink is not given. |
| [4] | B. V. S. Reddy, C. Velampalli | A multiple access scheme is |
| | and S. S. Das, “Performance | given for OTFS, OTSM, and |
| | Analysis of MultiUser OTFS, | block SC. However the peak |
| | OTSM, and Single Carrier in | power of the transmission is |
| | Uplink,” in IEEE TCOM, vol. | higher as in single user |
| | 72, no. 3, pp. 1428-1443, | scenarios. |
| | March 2024 | |
| [5] | R. Hadani et al. “Multiple | It allocates resources in the |
| | access in an orthogonal time | time-frequency domain rather |
| | frequency space | than directly in the delay- |
| | communication system” US | Doppler domain. This scheme is |
| | patent U.S. Pat. No. | limited to only the OTFS |
| | 10,090,973B2, September 2016 | waveform. |
| [6] | S. Rakib et al. “Multiple Access | Users multiplexed in de-Do |
| | in wireless communications | (delay doppler) domain & |
| | system for high-mobility | Doppler division multiplexing |
| | applications” US patent | (DoDM) with guard delay bins |
| | U.S. Pat. No. 9,722,741B1, | and guard doppler bins but the |
| | August 2017 | use of guard bands leads to loss |
| | | of spectral efficiency |
| [7] | J. Delfeld et al. “Uplink user | Only Doppler domain resources |
| | resource allocation for | are allocated to users to reduce |
| | orthogonal time frequency | the peak power of the |
| | space modulation” US Patent | transmitted signal. |
| | U.S. Pat. No. 10,965,348B2, | |
| | March 2021 | |

Hence there is a need in the art for a new multiple access mechanism based system that would address the drawbacks of the current OFDMA architecture and multiple access schemes involving waveforms such as OTFS (orthogonal time frequency space), OTSM (orthogonal time sequency multiplexing), and block single carrier (SC). There is also a need in the art to reduce the peak power for the transmission of individual users that would be addressed by the present system whereby the resources would be directly allocated in the delay-Doppler domain or a virtual delay-Doppler domain derived from available time-frequency resources free of any requirement of delay-Doppler guard bins.

### OBJECTS OF THE INVENTION

It is thus the basic object of the present invention to provide for multiple access mechanism-based system that would be resilient in high-speed scenarios, would reduce peak power and would simplify signal generation.

It is another object of the present invention to provide for said multiple access mechanism-based system that would be that would facilitate the development of multi-user receivers for practical pulse shapes and would overcome the problem in the art.

It is yet another object of the present invention to provide for said multiple access mechanism-based system with high reliability requirements that would reduce power consumption for battery driven devices towards their uplink transmission due to less complex and low peak power-based waveform generation.

It is still another object of the present invention to provide for said multiple access mechanism-based system by involving waveforms such as OTFS (orthogonal time frequency space), OFDM, OTSM (orthogonal time sequency multiplexing), and block single carrier (SC), and such that each user transmission is spread across the entire time-frequency grid, resulting in a high diversity advantage in reception.

It is still a need in the art to provide for said mechanism-based system that would reduce peak power transmission of individual users that can be addressed allocating the resources directly in the delay-Doppler domain or a virtual delay-Doppler domain derived from available time-frequency resources free of any requirement of delay-Doppler guard bins.

### SUMMARY OF THE INVENTION

Thus, according to the basic aspect of the present invention there is provided an unified multiple access (MA) based system for uplink transmission of data by multiple users comprising
user interface integrated transmitter modules for transmitting the data from multiple user transmitters over waveforms through a cooperative unified data grid structure including grid points, said unified data grid structure including each user transmitter allocation of a few non-overlapping grid points for loading respective data bearing symbols, with zeros loaded onto unallocated grid points;
said each user transmitter selectively configured to transmit a sparsely loaded grid resembling to the unified two-dimensional data grid structure involving data-bearing Quadrature Amplitude Modulation (QAM), where a part of available grid points of the grid as allocated is loaded with QAM symbols and remaining grid points are loaded with zero symbols;
waveform modulator corresponding to said each user transmitter for waveform modulation of said sparsely loaded grid as per the waveforms enabling transmission for multi-antenna reception of the waveforms to a base station or an access point.

In the above system, the waveforms include OTFS (orthogonal time frequency space) or OFDM (orthogonal frequency division multiplexing) or OTSM (orthogonal time sequence multiplexing) or block single carrier (SC) waveforms.

The above system includes a processor in operative connection for creating the two-dimensional data grid structure of desired size for sparsely/partially allocating data-bearing Quadrature Amplitude Modulation (QAM) or phase shift keying (PSK) modulation symbols onto grid points ensuring systematic allocation of grid points to user transmitters for transmission in the uplink and each allocated grid point is separated from other allocated grid points by a minimum distance in terms of number of grid points: β1 along the row dimension and β2 along the column dimension, where a unique vertical and a horizontal offset is applied to each user with respect to a reference grid point, maintaining a distance β1 along vertical dimension and a distance β2 along horizontal dimension to load the data symbols, while zero symbols are loaded on the other grid points.

In the above system, the user transmitter sparsely/partially allocates said QAM symbols based on loading fewer than maximum symbols at grid points of said grid of certain grid size with zero symbols loaded onto remaining grid points and to which grid for loading symbols of each other user is applied vertical and horizontal offset with respect to a reference grid point by maintaining said distance β1 along vertical dimension and a distance β2 along horizontal dimension of said grid while zero symbols are loaded onto other grid points, thereby enabling the QAM symbol loading onto the grid in an unified manner across said waveforms and their modulation for transmission followed by the multi-antenna reception of the waveforms at the base station (BS) that is resilient in multi user high-speed scenarios in involving low peak power for waveform transmission in turn reducing the related non-linear effects of high power amplifier for signal transmission.

In the above system, the user transmitters allow transmitting data to base station (BS) ensuring that each user transmission is spread across the entire time-frequency grid enabled by direct allocation of resources in said two-dimensional data grid of delay-Doppler and Doppler domain selectively derived from available time-frequency resources including but not limited to delay-Doppler domain, delay-sequency, delay-time domain for said waveforms including OTFS, OTSM, or block SC and virtual delay-Doppler domain for transmission in OFDM based systems free of any requirement of delay-Doppler guard bins thereby enabling additional channel diversity for receivers.

In the above system, the two-dimensional data grid structure created by the processor is of size M×N, containing MN grid points sparsely loaded with fewer than maximum MN QAM symbols preferably I<MN QAM symbols for transmission, said QAM symbols in the grid being spaced by β1 vertically and β2 horizontally for OTFS and OTSM, the M and N can be any integer numbers depends on available bandwidth and frame duration requirements;
wherein when the grid parameters M and N are not divisible by β1 and β2 respectively, a reduced grid size M_{new}×N_{new} is selected with M_{new}≤M and N_{new}≤N so as to be divisible by β1 and β2 respectively for fewer/partial QAM symbols loading on available grid points with I and MN being related with β1 and β2 as follows:

$$I = \frac{M N}{{β}_{1} {β}_{2}} \qquad ( 1 )$$

In the above system, for loading of symbols onto said grid by multiple users have the same distance parameters, but their QAM symbols are positioned differently on the grid, with different vertical offset and horizontal offset with reference to the first user grid point allocation.

In the above system, all possible combinations for the vertical and horizontal offsets are denoted by Iₒ∈C^{β1β2×1} and kₒ∈C^{β1β2×1} respectively for loading QAM symbols by the users of the system and are computed by said processor as

$${I}_{\text{?}} = {{[ \begin{matrix}{I}_{\text{?}} \\ ⋮ \\ {I}_{\text{?}}\end{matrix} ]}_{\text{?}} [ 0 , 1 , … , {β}_{1} - 1 ]}^{T} , \qquad ( 2 )$$

$${k}_{\text{?}} = {[ v , {Ψ}^{\text{?}} v , … , {Ψ}^{\text{?}} v ] [ 0 , 1 , … , {β}_{2} - 1 ]}^{T} , \qquad ( 3 )$$

$$\text{?} \text{indicates text missing or illegible when filed}$$

where v∈C^{β1β2×1}=[1_{β1}^{T}, 0_{β1β2-β1}^{T}] T and ψ=π_{β1β2}, is a cyclic forward permutation matrix of order β1β2. Each κ^{th} element of Io and ko, for κ=0, 1, . . . , β1β2−1 are Iₒ[κ]∈{0, 1, . . . , β1−1} and kₒ[κ]∈{0, 1, . . . , β2−1}, respectively,
wherein for each u^{th} user, where u=1, 2, . . . , U, vector considered is du=[d[0], d[1], . . . , d[i] . . . , d[I−1]]T comprising of I QAM symbols for transmission with said QAM symbols being loaded onto said grid represented by M×N matrix X⁻ u, with elements “xu(I, k) as the grid points, for I=0, 1, . . . , M−1 and k=0, 1, . . . , N−1, as

$${{x}^{\text{?}}}_{\text{?}} ( l , k ) = \{ \begin{matrix}{d}_{\text{?}} [ i ] & \begin{matrix}if & l = {( i )}_{\text{?}} {β}_{1} + {l}_{\text{?}} [ u ] \\ & k = ⌊ \frac{\text{?}}{\text{?}} ⌋ {β}_{2} + {k}_{\text{?}} [ u ]\end{matrix} \\ 0 & Otherwise ,\end{matrix} \qquad ( 4 )$$

$$\text{?} \text{indicates text missing or illegible when filed}$$

wherein vectorization of \tilde{X}ᵤ results in a vector \tilde{x}ᵤ∈ [symbol] ^{MN×1}, expressed as

$${{x}^{\text{?}}}_{\text{?}} = {J}_{\text{?}} {d}_{\text{?}} , \qquad ( 5 )$$

$$\text{?} \text{indicates text missing or illegible when filed}$$

wherein Jᵤ is a matrix of size MN×I with the elements of this matrix, jᵤ(n, i), for n=0, 1, . . . , MN−1 and i=0, 1, . . . , I−1 given as

$${\text{?}}_{\text{?}} ( n , i ) = \{ \begin{matrix}1 & if n = {( i )}_{\text{?}} {β}_{1} + {l}_{\text{?}} [ u ] + ⌊ \frac{\text{?}}{\text{?}} ⌋ {β}_{2} M + {k}_{\text{?}} [ u ] M \\ 0 & Otherwise ,\end{matrix} \qquad ( 6 )$$

$$\text{?} \text{indicates text missing or illegible when filed}$$

In the above system, said data symbols loaded in \tilde{X}ᵤ grid space are transmitted by the transmitter in time domain by involving said waveform modulation defined by P and Q as per eq. (7) for different waveforms

| Waveform | OTFS | OFDM | OTSM | Block SC |
|---|---|---|---|---|
| P | F_{N}^{H} | I_{N} | W_{N} | I_{N} |
| Q | I_{M} | F_{M}^{H} | I_{M} | I_{M} |

expressed as

$${\text{?}}_{\text{?}} = vec ( Q {{X}^{\text{?}}}_{\text{?}} P ) , \qquad ( 7 )$$

$$= ( P ⊗ Q ) {{x}^{\text{?}}}_{\text{?}} , \qquad ( 8 )$$

$$\text{?} \text{indicates text missing or illegible when filed}$$

where sᵤ={s[n]}ₙ₌₀^{MN-1} is a discrete time signal, and P and Q are as listed in the above table for said different waveforms, optionally with a cyclic prefix (CP) included in sᵤ before transmission to accommodate channel delay spread.

In the above system, for said OTFS, OTSM, and block SC waveform modulation the following two-dimensional transformational computation takes place

$${X}_{\text{?}} = {F}_{M} {{X}^{\text{?}}}_{\text{?}} P . \qquad ( 9 )$$

$$\text{?} \text{indicates text missing or illegible when filed}$$

wherein said data symbols loaded in Xᵤ are in time frequency domain with the time domain signal getting generated by passing Xᵤ to a preferred waveform transmitter including OFDM transmitter.

In the above system, selection of the values for β₁ and 2 by said processor range between 1 and M−1, inclusive, and the range between 1 and N−1, inclusive, for β₁ and β₂ respectively, and, wherein preferably for a given β₁ and β₂ any number of users can be added for transmission between 1 and 1/β₁β₂.

In the above system, for selected values for β₁ and β₂ if the grid parameters M and/or N are not divisible by β₁ and/or β₂ respectively a reduced grid M_{otfs}≤M and N_{otfs}≤N is considered by said processor for processing for which β₁ and β₂ divide M_{otfs} and N_{otf}s, respectively wherein Zero symbols are loaded for the points between M_{otfs} and M and N_{otfs} and N.

The above system is applicable across wide range of uplink communications in all terrestrial and non-terrestrial digital Wireless Communication Systems, preferably suiting uplink communication of low power and reduced capability Internet of Things (IoT) devices enabling low transmission complexity and power consumption.

### BRIEF DESCRIPTION OF FIGURES

FIG. 1: Schematic showing data grid with partial loading;

FIG. 2: Schematic showing an uplink 4-user scenario with multi-antenna reception at BS;

FIG. 3: showing BLER performance comparison of the invented MA scheme among different waveforms for 16 QAM modulation, M=512 and N=16, EVA channel, speed 500 kmph, carrier frequency 4 GHz.

### DETAILED DESCRIPTION OF THE INVENTION WITH REFERENCE TO THE ACCOMPANYING DRAWINGS

Notations: Scalars, matrices, and vectors are denoted by x, x, and X, respectively. C^{M×N} represents the set of all matrices of size M×N. x(i, j) denotes the element in the i^{th} row and j^{th} column of the matrix X. x[n] represents the n^{th} element of the vector x. I_{N}, F_{N}, and W_{N} represent an Identity, normalized discrete Fourier transform (DFT), and normalized Walsh-Hadamard matrices of size N×N, respectively. A vector of length N with all zeros is represented by 0_{N}, and one with all ones is represented by 1_{N}. The juxtaposition of variables such as xy denotes multiplication between x and y. ( )^{T} and ( )^{H} signify the transpose and conjugate transpose operations, respectively. vec (X) vectorizes X. If x∈C^{N×1}, diag (x) is an N×N diagonal matrix.

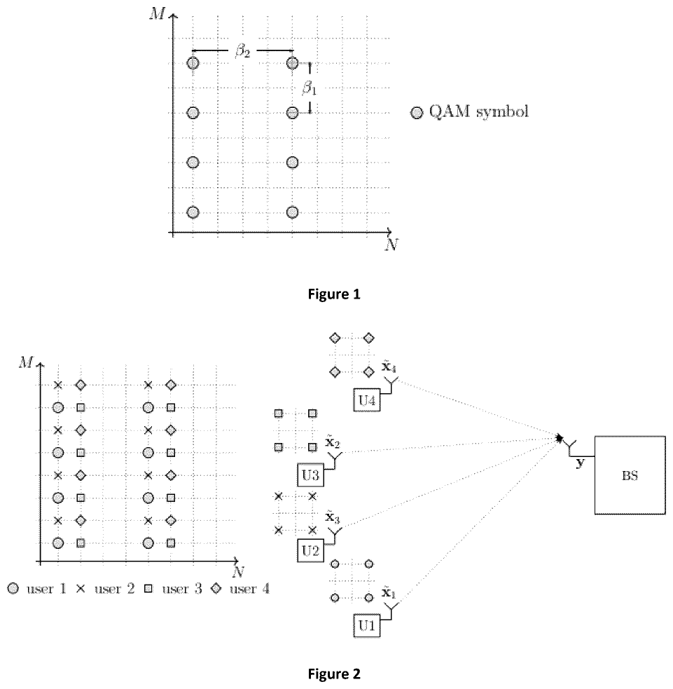

As discussed hereinbefore, the present invention provides for multiple access mechanism-based system that addresses the drawbacks of the current OFDMA architecture. The multiple access (MA) mechanism-based system of the present invention involves waveforms orthogonal time frequency space (OTFS), orthogonal time sequency multiplexing (OTSM), and block single carrier (SC) for transmitting data by multiple users to a base station (BS). For each waveform, a data grid of size M×N is considered. After loading data symbols onto the grid points, a modulation referred to as waveform modulation is performed to generate a time domain signal for transmission. The waveform modulation varies by type: for OTFS, an N-point IDFT is performed over the columns of the grid; for OFDM, an M-point IDFT is done over the rows; for OTSM, an N-point WHT is applied along the columns; and for single carrier, direct transmission with row-column interleaving is used. In this system, a processor is provided for allocating transmitter users a few non-overlapping grid points for loading data symbols, with zeros loaded onto unallocated grid points. Users generate the waveform for transmission using the appropriate waveform modulation corresponding to the selected waveform (OTFS, OFDM, OTSM, or single carrier). The processor of the present system executes a systematic allocation of grid points to transmitter users for transmission in the uplink. Each allocated grid point is separated from other allocated grid points by a minimum distance in terms of the number of grid points: β1 along the row dimension and β2 along the column dimension. An example of this allocation shown for a single user in FIG. 1 and for four users is shown in FIG. 2, where M=8, N=8, β₁=2, and β2=4 are used.

In a preferred embodiment of the present system, OTFS, OTSM, OFDM, and block SC based transmissions of the data by transmitters of the system, anunified two-dimensional data grid structure is formed. The data-bearing Quadrature Amplitude Modulation (QAM) is loaded onto these grid points for transmission. A data grid of size M×N, containing MN grid points, is considered in this scenario.

In the present invention, each user transmitter transmits a sparsely loaded grid resembling to the, which implies fewer than the maximum MN QAM symbols are sent. Precisely, I<MN QAM symbols are transmitted. As illustrated in FIG. 1, QAM symbols in the grid are spaced by β₁ vertically and β₂ horizontally for OTFS and OTSM waveforms. The grid size M×N is assumed to be 8×8, with β₁=2 and β₂=4. This is under the assumption that both M and N are divisible by β₁ and β₂ respectively. If the grid parameters M and N are not divisible by β₁ and β₂ respectively, a reduced grid size M_{new}×N_{new} is chosen, with M_{new}≤M and N_{new}≤N. They are selected to be divisible by β₁ and β₂ respectively. As fewer QAM symbols are loaded than the available grid points, this method is called partial loading. The terms I and MN are related by β₁ and β₂ as follows:

$$I = \frac{MN}{{β}_{1} {β}_{2}} \qquad ( 1 )$$

By loading zero symbols onto the remaining grid points, the grid will undergo waveform modulation for OTFS, OTSM, OFDM or block SC waveforms. For other users, the QAM symbols are loaded sparsely, following a similar pattern with an offset that allows for a shift in the vertical and horizontal directions.

FIG. 2 illustrates the loading of QAM symbols onto the grid with four users. User 2, User 3, and User 4 have the same distance parameters as User 1, but their QAM symbols are positioned differently on the grid. User 2's symbols have a vertical offset of 1 and no horizontal offset compared to User 1. User 3's symbols are horizontally offset by 1 without any vertical offset. User 4's symbols have both a horizontal and vertical offset of 1. Since β₁β₂=8, a similar symbol allocation can be made for four more users. All possible combinations for the vertical and horizontal offsets, denoted by Iₒ∈C^{β1β2×1} and kₒ∈C^{β1β2×1} respectively, for loading QAM symbols by the users, are given as

$${I}_{\text{?}} = {{[ \begin{matrix}{I}_{\text{?}} \\ ⋮ \\ {I}_{\text{?}}\end{matrix} ]}_{\text{?}} [ 0 , 1 , … , {β}_{1} - 1 ]}^{T} , \qquad ( 2 )$$

$${k}_{\text{?}} = {[ v , {Ψ}^{\text{?}} v , … , {Ψ}^{\text{?}} v ] [ 0 , 1 , … , {β}_{2} - 1 ]}^{T} , \qquad ( 3 )$$

$$\text{?} \text{indicates text missing or illegible when filed}$$

where v∈C^{β1β2×1}=[1_{β1}^{T}, 0_{β1β2-β1}^{T}] T and ψ=π_{β1β2}, is a cyclic forward permutation matrix of order β₁β₂. Each κ th element of Io and ko, for κ=0, 1, . . . , β₁β₂−1 are Iₒ[κ]∈{0, 1, . . . , β₁−1} and kₒ[κ]∈{0, 1, . . . , β₂−1}, respectively,
wherein for each u th user, where u=1, 2, . . . , U, vector considered is dᵤ=[d[0], d[1], . . . , d[i] . . . , d[I−1]]T comprising of I QAM symbols for transmission. These QAM symbols are loaded onto a grid represented by M×N matrix X⁻ᵤ, with elements “xᵤ(I, k) as the grid points, for I=0, 1, . . . , M−1 and k=0, 1, . . . , N−1, as

$${{x}^{\text{?}}}_{u} ( l , k ) = \{ \begin{matrix}{d}_{u} [ i ] & \begin{matrix}if & l = {( i )}_{\text{?}} {β}_{1} + {l}_{\text{?}} [ u ] \\ & k = ⌊ \frac{\text{?}}{\text{?}} ⌋ {β}_{2} + {k}_{\text{?}} [ u ]\end{matrix} \\ 0 & Otherwise ,\end{matrix} \qquad ( 4 )$$

$$\text{?} \text{indicates text missing or illegible when filed}$$

The vectorization of \tilde{X}ᵤ results in a vector \tilde{x}ᵤ∈ [symbol] ^{MN×1}, that can be expressed as

$${{x}^{\text{?}}}_{\text{?}} = {J}_{\text{?}} {d}_{\text{?}} , \qquad ( 5 )$$

$$\text{?} \text{indicates text missing or illegible when filed}$$

wherein Jᵤ is a matrix of size MN×I with the elements of this matrix, jᵤ(n, i), for n=0, 1, . . . , MN−1 and i=0, 1, . . . , I−1 given as

$${\text{?}}_{\text{?}} ( n , \text{?} ) = \{ \begin{matrix}1 & if n = {( i )}_{\text{?}} {β}_{1} + {l}_{\text{?}} [ u ] + ⌊ \frac{\text{?}}{M} ⌋ {β}_{2} M + {k}_{\text{?}} [ u ] M \\ 0 & Otherwise ,\end{matrix} \qquad ( 6 )$$

$$\text{?} \text{indicates text missing or illegible when filed}$$

TABLE 3
description of P and Q in (7) for different waveforms

| Waveform | OTFS | OFDM | OTSM | Block SC |
|---|---|---|---|---|
| P | F_{N}^{H} | I_{N} | W_{N} | I_{N} |
| Q | I_{M} | F_{M}^{H} | I_{M} | I_{M} |

The data symbols loaded in \tilde{X}ᵤ are transmitted in the time domain using waveform modulation by a suitable modulator, which can be expressed for OTFS, OFDM, OTSM, and block SC as

$${\text{?}}_{\text{?}} = vec ( Q {{X}^{\text{?}}}_{\text{?}} P ) , \qquad ( 7 )$$

$$= ( P ⊗ Q ) {{x}^{\text{?}}}_{u} , \qquad ( 8 )$$

$$\text{?} \text{indicates text missing or illegible when filed}$$

where sᵤ={s[n]}ₙ₌₀^{MN-1} is a discrete time signal, and P and Q are listed in Table 3 for different waveforms. A cyclic prefix (CP) may be included in sᵤ before transmission to accommodate channel delay spread.

Alternatively, for OTFS, OTSM, and block SC waveform modulation can also be achieved by applying the following two-dimensional transform

$${X}_{u} = {F}_{M} {{X}^{\text{?}}}_{u} P . \qquad ( 9 )$$

$$\text{?} \text{indicates text missing or illegible when filed}$$

The samples of Xᵤ are in the time frequency domain, hence the time domain signal can be generated by passing Xᵤ to an OFDM transmitter.

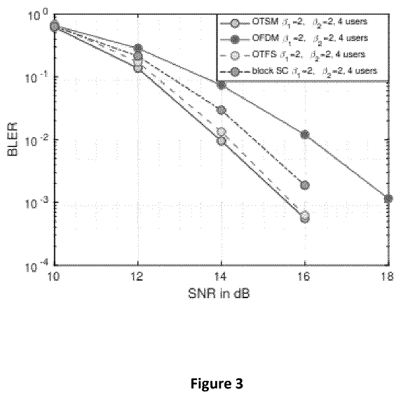

The MA mechanism based system of the present invention, with distance parameters β₁=2 and β₂=2, is evaluated using a successive interference cancellation receiver for 4 users in the uplink. The block error rate (BLER) comparison among OTFS, OTSM, OFDM, and block SC is illustrated in FIG. 3. Both OTFS and OTSM outperform OFDM by 2 dB SNR at a BLER of 10⁻², while block SC performs 1.25 dB better than OFDM.

Thus, according to the basic embodiment of the present invention a multi-user transmission mechanism based system is provided in uplink to a base station or an access point with waveforms OTFS, OTSM, or block SC.

Preferably each user transmission mechanism based system is provided, wherein the data symbols are sparsely loaded onto the two-dimensional grid of delay-Doppler, delay-Sequency, or delay-time domain for the waveforms OTFS, OTSM, or block SC, respectively.

According to a preferred aspect of the present invention there is provided said system with two dimensional grid whereby the grid can also be virtual and formed from the available resource elements for transmission in OFDM-based systems, and preferably whereby the grid is sparsely loaded, where the loading of data symbols maintains a distance β₁ along the vertical dimension and a distance β₂ along the horizontal dimension between the data symbols, whereby Zero symbols are loaded in the other points of the grid.

A preferred system is provided wherein selection of the values for β₁ and β₂ as the range between 1 and M−1, inclusive, and the range between 1 and N−1, inclusive, for β₁ and β₂ respectively.

Preferably, for a given β₁ and β₂ any number of users can be added for transmission between 1 and 1/β₁β₂.

More preferably, if for selected values for β₁ and β₂ if the grid parameters M and/or N are not divisible by β₁ and/or β₂ respectively, a reduced grid M_{new}≤M and N_{new}≤N will be considered, for which β₁ and β₂ divide M_{new} and N_{new}, respectively. Zero symbols are loaded for the points between M_{new} and M and N_{new} and N.

Said system with said grid is provided with individual user sparse loading of QAM symbols, where a unique vertical and a horizontal offset is applied to each user with respect to a reference grid point, maintaining a distance β₁ along the vertical dimension and a distance β₂ along the horizontal dimension to load the data symbols, while zero symbols are loaded on the other grid points.

In a preferred embodiment, a partial load-based multiple access scheme/mechanism based system is provided for OTFS, OTSM, and block SC. Each user transmission is spread across the entire time-frequency grid, resulting in a high diversity advantage in reception. Peak power for the transmission of individual users is reduced.

The present mechanism based system is provided that allocates resources directly in the delay-Doppler domain or a virtual delay-Doppler domain derived from available time-frequency resources. Furthermore, the resource allocation scheme applies to OTSM and single carrier waveforms, in addition to OTFS, and in the present invention the delay-Doppler guard bins are not required.

Added to the above, both delay and Doppler domain resources are allocated, providing additional channel diversity for receivers.

### Unique Features of the Present Invention:—

An unified multiple access scheme based system is provided across the waveforms OTFS, OTSM, and block single carrier (SC).

The sparse loading of data symbols onto the grid in each user transmission reduces the peak power of the transmitting waveform from each user, thus reducing the non-linear effects of the high power amplifier.

### End Use and Application:—

The present invention is applicable across a wide range of uplink communication used in all terrestrial and non terrestrial digital Wireless Communication Systems.

For uplink communication of low power and reduced capability Internet of Things (IoT) devices, the presented MA schemes based system of the present invention are relevant for low transmission complexity and power consumption.

1. An unified multiple access (MA) based system for uplink transmission of data by multiple users comprising
user interface integrated transmitter modules for transmitting the data from multiple user transmitters over waveforms through a cooperative unified data grid structure including grid points, said unified data grid structure including each user transmitter allocation of a few non-overlapping grid points for loading respective data bearing symbols, with zeros loaded onto unallocated grid points;
said each user transmitter selectively configured to transmit a sparsely loaded grid resembling to the unified two-dimensional data grid structure involving data-bearing Quadrature Amplitude Modulation (QAM), where a part of available grid points of the grid as allocated is loaded with QAM symbols and remaining grid points are loaded with zero symbols;
waveform modulator corresponding to said each user transmitter for waveform modulation of said sparsely loaded grid as per the waveforms enabling transmission for multi-antenna reception of the waveforms to a base station or an access point.

2. The system as claimed in claim 1, wherein waveforms includes OTFS (orthogonal time frequency space) or OFDM (orthogonal frequency division multiplexing) or OTSM (orthogonal time sequence multiplexing) or block single carrier (SC) waveforms.

3. The system as claimed in claim 1, further includes a processor in operative connection for creating the two-dimensional data grid structure of desired size for sparsely/partially allocating data-bearing Quadrature Amplitude Modulation (QAM) or phase shift keying (PSK) modulation symbols onto grid points ensuring systematic allocation of grid points to user transmitters for transmission in the uplink and each allocated grid point is separated from other allocated grid points by a minimum distance in terms of number of grid points: β₁ along the row dimension and β₂ along the column dimension,
where a unique vertical and a horizontal offset is applied to each user with respect to a reference grid point, maintaining a distance β₁ along vertical dimension and a distance β₂ along horizontal dimension to load the data symbols, while zero symbols are loaded on the other grid points.

4. The system as claimed in claim 1, wherein the user transmitter sparsely/partially allocates said QAM symbols based on loading fewer than maximum symbols at grid points of said grid of certain grid size with zero symbols loaded onto remaining grid points and to which grid for loading symbols of each other user is applied vertical and horizontal offset with respect to a reference grid point by maintaining said distance β₁ along vertical dimension and a distance β₂ along horizontal dimension of said grid while zero symbols are loaded onto other grid points, thereby enabling the QAM symbol loading onto the grid in an unified manner across said waveforms and their modulation for transmission followed by the multi-antenna reception of the waveforms at the base station (BS) that is resilient in multi user high-speed scenarios in involving low peak power for waveform transmission in turn reducing the related non-linear effects of high power amplifier for signal transmission.

5. The system as claimed in claim 1, wherein the user transmitters allow transmitting data to base station (BS) ensuring that each user transmission is spread across the entire time-frequency grid enabled by direct allocation of resources in said two-dimensional data grid of delay-Doppler and Doppler domain selectively derived from available time-frequency resources including but not limited to delay-Doppler domain, delay-sequency, delay-time domain for said waveforms including OTFS, OTSM, or block SC and virtual delay-Doppler domain for transmission in OFDM based systems free of any requirement of delay-Doppler guard bins thereby enabling additional channel diversity for receivers.

6. The system as claimed in claim 3, wherein the two-dimensional data grid structure created by the processor is of size M×N, containing MN grid points sparsely loaded with fewer than maximum MN QAM symbols preferably I<MN QAM symbols for transmission, said QAM symbols in the grid being spaced by β₁ vertically and β₂ horizontally for OTFS and OTSM, the M and N can be any integer numbers depends on available bandwidth and frame duration requirements;
wherein when the grid parameters M and N are not divisible by β₁ and β₂ respectively, a reduced grid size M_{new}×N_{new} is selected with M_{new}≤M and N_{new}≤N so as to be divisible by β₁ and β₂ respectively for fewer/partial QAM symbols loading on available grid points with I and MN being related with β₁ and β₂ as follows:
$$I = \frac{MN}{{β}_{1} {β}_{2}} \qquad ( 1 )$$

7. The system as claimed in claim 6, wherein for loading of symbols onto said grid by multiple users have the same distance parameters, but their QAM symbols are positioned differently on the grid, with different vertical offset and horizontal offset with reference to the first user grid point allocation.

8. The system as claimed in claim 7, wherein all possible combinations for the vertical and horizontal offsets are denoted by Iₒ∈Cβ₁β₂×1 and kₒ∈Cβ₁β₂×1 respectively for loading QAM symbols by the users of the system and are computed by said processor as
$${I}_{\text{?}} = {{[ \begin{matrix}{I}_{\text{?}} \\ ⋮ \\ {I}_{\text{?}}\end{matrix} ]}_{\text{?}} [ 0 , 1 , … , {β}_{1} - 1 ]}^{T} , \qquad ( 2 )$$
$${k}_{\text{?}} = {[ v , {Ψ}^{\text{?}} v , … , {Ψ}^{\text{?}} v ] [ 0 , 1 , … , {β}_{2} - 1 ]}^{T} , \qquad ( 3 )$$
$$\text{?} \text{indicates text missing or illegible when filed}$$
where v∈C^{β1β2×1}=[1_{β1}^{T}, 0_{β1β2-β1}^{T}] T and ψ=π_{β1β2}, is a cyclic forward permutation matrix of order β₁β₂. Each κ^{th} element of Io and ko, for κ=0, 1, . . . , β₁β₂−1 are Iₒ[κ]∈{0, 1, . . . , β₁−1} and kₒ[κ]∈{0, 1, . . . , β₂−1}, respectively,
wherein for each u^{th} user, where u=1, 2, . . . , U, vector considered is du=[d[0], d[1], . . . , d[i] . . . , d[I−1]]T comprising of I QAM symbols for transmission with said QAM symbols being loaded onto said grid represented by M×N matrix X⁻ u, with elements “xu(I, k) as the grid points, for I=0, 1, . . . , M−1 and k=0, 1, . . . , N−1, as
$${{x}^{\text{?}}}_{\text{?}} ( l , k ) = \{ \begin{matrix}{d}_{\text{?}} [ i ] & \begin{matrix}if & l = {( i )}_{\text{?}} {β}_{1} + {l}_{\text{?}} [ u ] \\ & k = ⌊ \frac{\text{?}}{\text{?}} ⌋ {β}_{2} + {k}_{\text{?}} [ u ]\end{matrix} \\ 0 & Otherwise ,\end{matrix} \qquad ( 4 )$$
$$\text{?} \text{indicates text missing or illegible when filed}$$
wherein vectorization of \tilde{X}ᵤ results in a vector \tilde{x}ᵤ∈ [symbol] ^{MN×1}, expressed as
$${{x}^{\text{?}}}_{\text{?}} = {J}_{\text{?}} {d}_{\text{?}} , \qquad ( 5 )$$
$$\text{?} \text{indicates text missing or illegible when filed}$$
wherein Jᵤ is a matrix of size MN×I with the elements of this matrix, jᵤ(n, i), for n=0, 1, . . . , MN−1 and i=0, 1, . . . , I−1 given as
$${\text{?}}_{\text{?}} ( n , \text{?} ) = \{ \begin{matrix}1 & if n = {( i )}_{\text{?}} {β}_{1} + {l}_{\text{?}} [ u ] + ⌊ \frac{\text{?}}{M} ⌋ {β}_{2} M + {k}_{\text{?}} [ u ] M \\ 0 & Otherwise ,\end{matrix} \qquad ( 6 )$$
$$\text{?} \text{indicates text missing or illegible when filed}$$

9. The system as claimed in claim 8, wherein said data symbols loaded in \tilde{X}ᵤ grid space are transmitted by the transmitter in time domain by involving said waveform modulation defined by P and Q as per eq. (7) for different waveforms

| Waveform | OTFS | OFDM | OTSM | Block SC |
|---|---|---|---|---|
| P | F_{N}^{H} | I_{N} | W_{N} | I_{N} |
| Q | I_{M} | F_{M}^{H} | I_{M} | I_{M} |

expressed as
$${\text{?}}_{\text{?}} = vec ( Q {{X}^{\text{?}}}_{\text{?}} P ) , \qquad ( 7 )$$
$$= ( P ⊗ Q ) {{x}^{\text{?}}}_{u} , \qquad ( 8 )$$
$$\text{?} \text{indicates text missing or illegible when filed}$$
where sᵤ={s[n]}ₙ₌₀^{MN-1} is a discrete time signal, and P and Q are as listed in the above table for said different waveforms, optionally with a cyclic prefix (CP) included in sᵤ before transmission to accommodate channel delay spread.

10. The system as claimed in claim 9, wherein for said OTFS, OTSM, and block SC waveform modulation the following two-dimensional transformational computation takes place
$${X}_{\text{?}} = {F}_{M} {{X}^{\text{?}}}_{u} P , \qquad ( 9 )$$
$$\text{?} \text{indicates text missing or illegible when filed}$$
wherein said data symbols loaded in Xᵤ are in time frequency domain with the time domain signal getting generated by passing Xᵤ to a preferred waveform transmitter including OFDM transmitter.

11. The system as claimed in claim 6, wherein selection of the values for β₁ and β₂ by said processor range between 1 and M−1, inclusive, and the range between 1 and N−1, inclusive, for β₁ and β₂ respectively, and, wherein preferably for a given β₁ and β₂ any number of users can be added for transmission between 1 and 1/β₁β₂.

12. The system as claimed in claim 11, wherein for selected values for β₁ and β₂ if the grid parameters M and/or N are not divisible by β₁ and/or β₂ respectively a reduced grid M_{otfs}≤M and N_{otfs}≤N is considered by said processor for processing for which β₁ and β₂ divide M_{otfs} and N_{otf}s, respectively wherein Zero symbols are loaded for the points between M_{otfs} and M and N_{otfs} and N.

13. The system as claimed in claim 1, is applicable across wide range of uplink communications in all terrestrial and non terrestrial digital Wireless Communication Systems, preferably suiting uplink communication of low power and reduced capability Internet of Things (IOT) devices enabling low transmission complexity and power consumption.
